(19) United States
(12) Patent Application Publication
(10) Pub. No.: US 2023/0373835 A1
(43) Pub. Date: Nov. 23, 2023

(54) Relating to the Treatment of Matrices and/or the Contents of Matrices

(71) Applicant: EKO HARDEN TECHNOLOGIES OY, Espoo (FI)

(72) Inventor: Erkki Lindberg, Sundsberg (FI)

(21) Appl. No.: 18/155,575

(22) Filed: Jan. 17, 2023

Related U.S. Application Data
(63) Continuation of application No. 15/531,990, filed on May 31, 2017, now abandoned.

(30) Foreign Application Priority Data
Dec. 1, 2014 (GB) 1421261.7
Dec. 1, 2014 (GB) 1421263.3

(51) Int. Cl. C02F 11/00; C02F 1/66; C10G 15/08; C02F 1/467; B09C 1/00; C02F 1/00; C02F 1/469; C02F 101/36; C02F 1/461; C02F 101/34; C02F 103/36; C02F 101/32; C02F 103/00; C02F 103/06; C02F 101/30; C02F 1/42; C02F 103/10

(52) U.S. Cl. CPC C02F 11/006; C02F 1/66; C10G 15/08; C02F 1/4672; B09C 1/002; B09C 1/00; C02F 1/008; C02F 1/4698; C02F 2101/363; C02F 2001/46138; C02F 2101/345; C02F 2103/365; C02F 2101/32; C02F 2201/4614; C02F 2103/007; C02F 2103/06; C02F 2201/46175; C02F 2305/023; C02F 2101/305; C02F 1/42; C02F 2201/4613; C02F 2103/10; C02F 2101/327; C02F 2101/366; C02F 2201/46135; C02F 2201/4615

(57) ABSTRACT

A method and apparatus break down organic materials, typically contaminants, through oxidation. The method for the treatment of a volume of material, provides: a) introducing at least two electrodes into a location, the location containing the volume of material and the volume of material containing one or more species for treatment; b) providing connections between a voltage source and the at least two electrodes; c) applying a voltage of a first polarity to the connections for a first period of time, under the control of a voltage controller; d) applying a voltage of a second, reversed, polarity to the connections for a second period of time, under the control of the voltage controller; e) repeating steps c) and d) a plurality of times; preferably with steps c), d) and e) promoting oxidation of one or more of the one or more species for treatment.

### CROSS-REFERENCE TO RELATED APPLICATIONS

This application is a continuation of U.S. application Ser. No. 15/531,990, filed May 31, 2017, which is a US nationalization of PCT Application No. PCT/EP2015/078246, filed Dec. 1, 2015, which claims priority to GB Application No. 1421263.3, filed Dec. 1, 2014, and GB Application No. 1421261.7, filed Dec. 1, 2014, which are all incorporated herein by specific reference.

### BACKGROUND OF THE INVENTION

### 1. The Field of the Invention

This invention concerns improvements in and relating to the treatment of matrices and/or the contents of matrices, in particular but not exclusively the treatment of man-made or geological structures, such as tailings or soil, and/or of compounds, such as contaminants, found within such structures.

### 2. The Relevant Technology

In a variety of situations, compounds are known to exist within a man-made or geological structure. The geological structure may be a relatively shallow one such as a volume of soil. The geological structure may be a relatively deep one beneath the surface, such as an aquifer. The geological structure may be an ocean, sea or lake bottom sediment. The geological structure may be a naturally occurring volume of liquid, such as a lake or pond, including such compounds in the liquid phase and/or suspended in the liquid phase. The man made structure may be a volume within a storage site, such as a tailings pond or settlement tank. In the many and various possibilities the compounds may be ones which have been introduced, deliberately or inadvertently, for instance contaminants.

The contaminants can be in many various forms, including organic compounds.

Existing approaches to the treatment of such matrices to deal with such compounds are time consuming, expensive in terms of capital equipment and expensive in terms of operation, for instance power consumption or chemicals such as hydrogen peroxide. The existing approaches also tend to be very situation specific and so are not widely applicable or they require a large amount of reconfiguration between different situations. Existing solutions can also cause secondary pollution such as gases or noise.

### SUMMARY OF THE INVENTION

The present invention has amongst its potential aims to provide a method and apparatus which offers a beneficial approach to breaking down organic materials through oxidation.

The present invention has amongst its potential aims to provide a method and apparatus which provide a more generally applicable treatment technique.

The present invention has amongst its potential aims to provide a low power consumption and/or short duration process and apparatus for the treatment of man-made or geological structures, particularly to reduce the level of contamination present within those.

According to a first aspect of the invention there is provided a method for the treatment of a volume of material, the method including:
a) introducing at least two electrodes into a location, the location containing the volume of material and the volume of material containing one or more species for treatment;
b) providing connections between a voltage source and the at least two electrodes; c) applying a voltage of a first polarity to the connections for a first period of time, under the control of a voltage controller;
d) applying a voltage of a second, reversed, polarity to the connections for a second period of time, under the control of the voltage controller;
e) repeating steps c) and d) a plurality of times;
preferably with steps c), d) and e) promoting oxidation of one or more of the one or more species for treatment.

The treatment may be to reduce the volume of one or more compounds, such as contaminants present in the location. The treatment may be to reduce the level of one or more compound, such as contaminants present in the location. The treatment may be to alter the form of one or more compounds, such as contaminants, for instance by converting them to one or more less toxic and/or hazardous compounds.

The volume of material may be or contain a liquid. The liquid may be water, including groundwater and/or brine and/or salt water and/or water bearing contaminants.

The volume of material may be a matrix, for instance a matrix which is a mixture of liquid and solid, such as a slurry and/or a sludge. The matrix may include one or more types of clay and/or rock particles and/or drilling materials, including drilling muds.

The volume of material may be a by-product of a process, for instance a drilling process or a mining process or an extraction process. The volume of material may be a waste stream, for instance sewage. The volume of material may be contaminated material, for instance soil or other minerals.

The volume of material may be treated according to the method as it is formed, shortly after it is formed, for instance within 10 hours, or a prolonged period after it has formed, for instance after 1 month or more.

The location may be man-made location. The location may be a location built to contain the volume of material. The location may be a tank or other form of container. The location may be a tailings pond or dammed area or pit or lake or pond. The location may be built to support the volume of material, for instance a volume of matrix, for instance a volume of solid material.

The location may be a naturally occurring location. The location may have been altered by human activity, for instance pre-processed. The location may be an aquifer or lake or pond.

The volume of material may be introduced to the location, for instance by being excavated and removed to the location or for instance by being directed to the location by a prior process, such as flowing to the location.

The volume of material may be already at the location, for instance by being naturally occurring at the location and/or by being found at the location by investigations, such as for contamination.

The one or more species may include one or more of the following: organic compounds, light hydrocarbons (for instance C10 or less), heavy hydrocarbons (for instance C11 or more), aliphatic organics (for instance C10 to C40), benzene, toluene, ethyl benzene, xylenes, polycyclic aromatic hydrocarbons, chlorinated phenyls, chlorophenols, polychlorinated biphenyls, biphenols, perchloroethylenes, tricholorethylenes, dioxins, perfluorooctanesulfonic acids, and/or perfluorooctanoic acids or other hydrocarbons.

The one or more species may include one or more of the following: lignite, fibric peat, hemic peat, sapric peat, phragmitic peat and other naturally occurring organic deposits.

According to a particular embodiment, the location may be a tailings pond or dammed area or pit or lake or pond. The location may be provided with an outlet for removing one or more liquids. The location may be provided with a plurality of outlets, different liquids being removed from the location through different outlets. An outlet may be provided for organic compounds, such as hydrocarbons, which are less dense than water. An outlet may be provided for water. An outlet may be provided for organic compounds, such as hydrocarbons, which are denser than water. One or more or all of the outlets may lead to a further processing stage. A pump or other means for moving the organic compounds, such as hydrocarbons, and/or water may be provided. The location may be a pre-existing location to which the method is applied, for instance a naturally occurring location with an oil and water mixture, potentially present as an emulsion. The location may be a location to which hydrocarbons are conveyed for the application of the method. The one or more electrodes may be provided in the oil and water layer, for instance by floating the electrodes, or components bearing the electrodes, on the oil and water layer or water layer thereunder. The two or more electrodes may have a length of up to 50 m, for instance up to 25 m.

The two or more electrodes may be of titanium, particularly titanium provided with a mixed metal oxide surface or coating. The two or more electrodes may be of steel.

The two or more electrodes may be spaced along the length of the location. The two or more electrodes may be spaced along the width of a location. The length and width of the location may be provided with an array of electrodes, for instance a regular array of electrodes. The spacing of the electrodes may be a common spacing between one electrode and the next across the width of the location. The spacing of the electrodes may be a common spacing across the length of the location. The spacing may be the same across the width as along the length of the location.

The spacing may be lower or higher across the width of the location when compared with the length of the location.

More electrodes may be provided in one or more parts of the location being treated compared with one or more other parts. The one or more parts may include the edges of the location being treated. The one or more parts may include the central 30% of the location being treated, considered by volume or considered by distance relative to the distance between one electrode at one extremity of the location and the electrode further away from that electrode. The one or more other parts may include the edges of the location being treated. The one or more other parts may include the central 30% of the location being treated, considered by volume or considered by distance relative to the distance between one electrode at one extremity of the location and the electrode further away from that electrode.

The spacing may be between 2 m and 30 m, for instance between 4 m and 12 m, and more particularly between 5 m and 10 m.

The electrodes may have an extent into the depth of the location of 10 m or more, preferably of 20 m or more and potentially up to 100 m.

The electrodes may have an extent into the depth of the location which is at least 20% of the depth of the location being treated, more preferably at least 50% of the depth of the location being treated.

The electrodes may be generally vertically provided, for instance +/−20 degrees to the vertical, ideally +/−5 degrees to the vertical.

The electrodes may be inserted into apertures formed within the volume of material. The apertures may be formed by drilling into the volume of material. The drills may subsequently be used as the electrodes. The apertures may be formed by driving or otherwise forcing an element into the volume of material. The elements may subsequently be used as the electrodes.

One or more material may be added to the aperture, before and/or during and/or after drilling or driving or forcing. The one or more materials may increase the conductivity between the electrodes and the volume of material compared with the conductivity when the one or more materials are absent. One or more pairs of alternative orientation electrodes may be provided. One or more sets of electrodes of alternative orientation may be provided. The alternative orientation may be horizontal +/−30 degrees, preferably +/−20 degrees and ideally +/−5 degrees. Such pairs or sets of electrodes may be provided in addition to the other pairs or sets of electrodes.

The alternative orientation pairs or sets of electrodes may be provided with connections and/or voltage pulse profiles and/or defined current pulse profiles and/or other characteristics as defined elsewhere for the pairs of electrodes or sets of electrodes.

The electrodes, particularly when provided in alternative orientations, may be positioned within the volume of material, for instance using gravity, for instance by allowing the electrodes to settle within the volume of material.

The electrodes, particularly when provided in alternative orientations, may be flexible electrodes. The flexible electrodes may be wires and/or cables and/or flexible rods. The electrodes, particularly the flexible electrodes, may be bare metal electrodes and/or be without any insulating coating or cover.

The connections may include the connection of the voltage source to two or more electrodes, those two or more electrodes forming a first set of electrodes. The voltage controller may provide a first set of operating conditions to the first set of electrodes.

The method may further include providing connections between the voltage source and two or more second set electrodes. The voltage controller may provide a second set of operating conditions to the second set of electrodes.

The method may further include providing connections between the voltage source and one of more still further sets electrodes. The voltage controller may provide a still further set of operating conditions to each of the still further sets of electrodes.

Each of the sets of operating conditions may be different from each of the other sets of operating conditions. Two or more of the operating conditions may be the same as each other. The operating conditions may include the voltage pulse profile applied, including the voltage pulse profile during different component parts of the voltage pulse profile, the magnitude of the pulse over its full cycle and during the different component parts and the duration of the full cycle and each of the component parts and the sequence of the component parts. The operating conditions may include one or more of: the voltage pulse profile applied; the voltage pulse profile during one or more or all of the different component parts of the voltage pulse profile; the magnitude of the pulse over its full cycle and/or during one or more or all of the different component parts; the duration of the full cycle and/or one or more or each of the component parts; or the sequence of the component parts.

Two or more of the sets of operating conditions may be the same except for the start time of the voltage pulse profile. The start time of the voltage pulse profile may be offset with respect to one or more or all of the other sets of operating conditions. The second set of operating conditions may be offset in time with respect to the start of its voltage pulse profile compared with the start of the voltage pulse profile of the first set of operating conditions. The still further sets of operating conditions may be provided with their own further offsets, potentially including an offset value for one of the still further sets of operating conditions which cause it to have the same phase as the first set of operating conditions. One or more of the still further sets of operating conditions may have a phase matching the first set of operating conditions. One or more of the still further sets of operating conditions may have a phase matching the second set of operating conditions. One or more of the still further sets of operating conditions may have a phase matching one of the other still further sets of operating conditions.

The first set of electrodes may include electrodes extending across the width of the location in a first set of positions, for instance in a row. The first set of electrodes may include electrodes extending across the width of the location at a second set of positions, for instance a second row. The first and second positions may be such that there are no intervening electrodes from other sets of electrodes. The first and second positions may be rows, relative to the length of the location, ideally with no rows of electrodes from one or more other sets of electrodes between them. In particular, the first set of electrodes may have a first row of electrodes and a second row of electrodes adjacent one another.

A second set of electrodes may be provided in addition to the first set of electrodes. The second set of electrodes may include electrodes extending across the width of the location in a second set of positions, for instance in a row. The second set of electrodes may include electrodes extending across the width of the location at a second set of positions, for instance a second row. The first and second positions may be such that there are no intervening electrodes from other sets of electrodes. The first and second positions may be rows, relative to the length of the location, ideally with no rows of electrodes from one or more other sets of electrodes between them. In particular, the second set of electrodes may have a first row of electrodes and a second row of electrodes adjacent one another. The second set of electrodes may be provided to one side, for instance relative to the length of the location, the first of the still further sets of electrodes may be provided to the other side. The various still further sets of electrodes may be provided in equivalent arrangements relative to one another.

In a preferred form, the first set of electrodes may be provided in two parallel rows, followed by the second set of electrodes in two parallel rows, followed by a further first set of electrodes in two parallel rows, followed by a further second set of electrodes in two parallel rows, potentially with one or more further repeats of this arrangement. Within each set of electrodes, it is preferred that one row is of a first polarity and the other row is of a different polarity. Corresponding rows in different sets of electrodes may be provided at the same polarity at the same time.

The voltage source may be connected to a mains power supply. The voltage source may be connected to a discrete power supply, for instance a power supply specific to the method and/or specific to the geographical location at which the method is conducted. The voltage source may be an AC voltage source or a DC voltage source. The voltage source may step down the voltage to the level required for the method. A constant voltage output may be provided. The constant voltage output may be between 2V and 50V, more preferably 6V to 25V.

The voltage controller may determine the voltage applied to one of the at least two electrodes. The voltage controller may determine the voltage applied to the electrodes in the first position in a set of electrodes, including the first set and/or second set and/or one or more of the still further sets. The voltage controller may apply a zero voltage or a different voltage to the other of the at least one electrodes. The voltage controller may apply a zero voltage or a different voltage to the electrodes in the second position in a set of electrodes, including the first set and/or second set and/or one of more of the still further sets. A zero voltage or a voltage of a different polarity may be applied to the other of the at least one electrodes. A zero voltage or a voltage of a different polarity may be applied to the electrodes in the second position in a set of electrodes.

The voltage controller may determine the voltage applied to the first position electrodes in a second set of electrodes. The voltage controller may apply a voltage and/or a polarity to the first position electrodes in the second set of electrodes which is different to the second position electrodes in the first set of electrodes. The voltage controller may determine the voltage applied to the first position electrodes in one or more or all of the still further sets of electrodes. The voltage controller may apply a voltage and/or a polarity to the first position electrodes in the one or more or all still further sets of electrodes which is different to the second position electrodes in the adjacent set of electrodes. In a preferred form, one row of electrodes is at a first voltage and/or first polarity, with the adjacent row of electrodes on one or both sides at a second voltage and/or polarity and/or a third voltage and/or polarity respectively. The second voltage and/or polarity and the third voltage and/or polarity may be the same. A voltage difference and/or polarity difference may be provided between all adjacent position electrodes.

The voltage applied may be in the form of a voltage pulse profile. The voltage pulse may have a first section during which the voltage is at a maximum value. The voltage pulse profile may have a second section during which the voltage is at a maximum value, but of opposing polarity. The voltage pulse profile may be a square wave profile. The duration of the first section and the duration of the second section are preferably the same.

In instances were transport of one or more parts of the matrix and/or one or more of the species being treated and/or one or more of the reaction products from the treatment of the one or more species is desired, then the first section and the second section may have different durations.

The first section and the second section are preferably adjacent one another. Preferably the second section is followed by a further first section. Preferably the further first section is followed by a further second section. Preferably alternating repeats of the first section and the second section are provided. In one embodiment of the invention, a third section is provided between the first section and the start of the second section. A fourth section may be provided between the second section and the start of a further first section. The sequence of first section, third section and second section may be repeated. The sequence of second section, fourth section and further first section may be repeated. The third section and/or fourth section may be a zero voltage section.

The first section and/or the second section may have a duration of between 10 ms and 500 ms, more particularly between 20 and 200 ms. The third section and/or fourth section may have a duration of 0.5 ms to 50 ms.

The voltage controller may provide a voltage, particularly a voltage pulse profile, to the one or more pairs of electrodes so as to provide and/or seek to provide a defined current pulse profile. The voltage, particularly the voltage pulse profile, may be determined through a calibration method, for instance a calibration method according to the third aspect of the invention.

The defined current pulse profile may include a first section. The defined current pulse profile may include a second section, preferably following on directly from the first section. The defined current pulse profile may include a third section, preferably following on directly from the second section or following on from a fourth section. The defined current pulse may include a first reversed section. The defined current pulse profile may include a second reversed section, preferably following on directly from the first reversed section. The defined current pulse profile may include a third reversed section, preferably following on directly from the second reversed section. The defined current pulse profile may include repeats of the sections, particularly with the first section following on directly from the third reversed section.

The first reversed section may have the equivalent profile shape but with a reversed current direction compared with the first section. The second reversed section may have the equivalent profile shape but with a reversed current direction compared with the second section. The third reversed section may have the equivalent profile shape but with a reversed current direction compared with the third section.

The first section may have a start current value and an end current value. The first section start current value may be zero. The first section end current value may be the maximum current for the defined current pulse profile. The first section may last for a first time period. The first time period may be less than 0.5 ms, more preferably less than 0.1 ms and ideally less than 0.05 ms. The first reverse section may be similarly provided.

The second section may have a start current value and an end current value. The second section start current value may be the maximum current for the defined current pulse profile. The current may decline between the start current value and the end current value. The end current value may be a declined current value. The declined current value may be the current value which occurs with the prolonged, for instance greater than 500 ms, application of the voltage in the corresponding part of the voltage pulse profile. The declined current value may be the value the current declines to, from the maximum current value, with the passage of time but represents a steady state current reached after a period of time. The decline current value may continue at that declined current value for a fourth section of a current pulse profile, with the fourth section intermediate the second section and the third section of the defined current pulse profile.

In the defined current pulse profile, a fourth section may be preferred. The fourth section may provide the, or a part of the, pulse section during which the volume of material or a part of the volume of material becomes charged. The fourth section may provide the charge which contributes to the second reversed section of the current pulse profile, for instance by contributing to the higher value of the current during the second reversed section of the current pulse profile. The fourth section may provide the charge which contributes to the first reversed section of the current pulse profile having a higher maximum current value that the minimum current value of the second reversed section, for instance by contributing to the higher value of the current during the first reversed section of the current pulse profile.

In the defined current pulse profile, a fourth reversed section may be preferred. The fourth reversed section may provide the, or a part of the, pulse section during which the volume of material or a part of the volume of material becomes charged. The fourth reversed section may provide the charge which contributes to the second section of the current pulse profile, for instance by contributing to the higher value of the current during the second section of the current pulse profile. The fourth reversed section may provide the charge which contributes to the first section of the current pulse profile having a higher maximum current value that the minimum current value of the second section, for instance by contributing to the higher value of the current during the first section of the current pulse profile.

The first section and/or second section may have a current value in excess of the fourth section current value due to the discharge of the charge provided to the volume or material or a part of the volume of material during the immediately previous fourth reversed section.

The first reversed section and/or second reversed section may have a current value in excess of the fourth reversed section current value due to the discharge of the charge provided to the volume or material or a part of the volume of material during the immediately previous fourth section.

In the defined current pulse profile it may be provided that no fourth section is present. It may be preferred that the end of the decline in current represents the transition point to the third section of the defined current pulse profile.

The second section may have a generally elliptical shape, with an initial rapid decrease in current and then decreasing rate of current decline down to the declined current value. The second reverse section may be similarly provided. Potentially there is no fourth reverse section between the second reverse section and the third reverse section in the defined current pulse profile.

The second section of the defined current pulse profile and/or the second reverse section of the defined current profile may have a duration of between 10 ms and 500 ms, more particularly between 20 and 200 ms.

The fourth section and the fourth reverse section may be absent from the defined current pulse profile, but may be present with a duration of less than 5 ms and more preferably less than 1 ms and ideally less than 0.5 ms.

The third section may have a start current value and an end current value. The third section start current value may be less than the maximum current for the defined current pulse profile and/or may be the declined current value. The third section end current value may be zero. The third section may last for a third time period. The third time period may be less than 0.5 ms, more preferably less than 0.1 ms and ideally less than 0.05 ms. The third reverse section may be similarly provided.

The second section and/or the second reverse section may include a current above the declined current value due to the voltage applied causing the one or more of the species to be treated and/or one or more components of the material, particularly of the matrix, to become charged according to the natural capacitance of the system.

The reduction in current between the start and end of the second section may cause and/or be indicative of the formation of free radicals within the material, preferably with these free radicals being involved in the oxidation reactions which treat one or more of the species.

The repeating of steps c) and d) a plurality of times, may include at least 1000 repetitions, more preferably at least 10,000 repetitions and ideally at least 500,000 repetitions. The repeating of steps c) and d) a plurality of times, may include more than 5 million repetitions, possibly more than 10 million repetitions and even possibly more than 25 million repetitions.

The method may promote oxidisation by generating free radicals within the material. The method may generate the free radicals at the surface of the solid species within the matrix, with respect to one or more or all of those solid species within the matrix.

Preferably the method has one or more or all of the following effects upon the matrix and/or upon one or more of the species:
breaking down one or more species present to one or more smaller species, preferably with reduced toxicity or reduced other undesirable characteristics and/or with more mobility within the matrix and/or with greater solubility;
reducing the level of contaminants present in the liquid, such as water, drawn off the method, for instance through breakdown of those compounds or changing their form; changing the surface chemistry of the matrix and/or one or more of the species, for instance in terms of their physical chemistry and/or in terms of the ions or other species present at the surface and/or the charge level of the surface, for instance so as to promote better settling of the materials or species within it and/or flocculation of the materials or species within it;
reduction in the volume of the material compared with its untreated form, for instance by more than 30%, more than 40% or even 50% or more.

Preferably the method has one or more or all of the following effects upon the matrix and/or one or more of the species between a first time at the start of the method's application and a second time after the method has been applied:
a reduction in the concentration of the C40 or more carbon atoms hydrocarbons by 20% or more, potentially by 35% or more, preferably by 50% or more, ideally by 70% or more;
a increase in the concentration of the C8 to C30 hydrocarbons by more than 100%, potentially by more than 200%, preferably by more than 500% and ideally by more than 700%;
an increase in the concentration of the less than C8 hydrocarbons (or organic compounds) by more than 25%, potentially by more than 50%, preferably by more than 100% and ideally by more than 200%;
a reduction in the concentration of the C8 or greater hydrocarbons by 10% or more, potentially 20% or more, preferably by 30% or more and ideally by 40% or more;
the conversion of a part of the hydrocarbons to water and carbon dioxide.

The time period between the first time period and the second time period may be between 20 hours and 2000 hours, potentially between 30 hours and 1000 hours, preferably between 60 hours and 400 hours and ideally between 75 hours and 300 hours.

The voltage pulse profile may generate electro-osmotic forces in a first direction, and then when the polarity is reversed, in the opposite direction for any one species present (depending upon its charge). The method may cause the charged contents of the pore water to move back and forward with the polarity changes. The method may cause freshly formed oxygen and hydroxyl free radicals formed in these electrochemical reactions to move back and forth. The method may promote the involvement of the free radicals in the oxidisation of the compounds present. The method may cause the free radicals to cause hydrocarbon chains to breakdown into lighter fractions and form carbon dioxide and water as by products.

The voltage pulse profile, particularly when the physical nature of the matrix is one with a moderate or low degree of compaction, means that the electrophoretic forces generated (which generally oppose the direction of electro-osmotic forces) cause small amounts of movement by the particulate material.

Optionally, the method includes control of the pH of the material, particularly the liquid phase. Preferably the pH is greater than 3, ideally greater than 4. The method of control may include the introduction of pH controlling compounds or species to the electrodes. The method preferably seeks to maintain the pH within the range at which any heavy metals to be treated according to the method remain as heavy metal ions and so are soluble. pH control may be provided by treatment of water extracted from and reintroduced to and/or introduced to the electrodes. A perforated barrier, such as a tube, may be provided around each electrode. The barrier may define a reservoir of water between the electrode and the material which is of the correct pH.

According to a second aspect of the invention there is provided apparatus for the treatment of a volume of material, the apparatus including:
a) at least two electrodes, the at least two electrodes being introduced into a location, the location containing the volume of material and the volume of material containing one or more species for treatment;
b) connections between a voltage source and the at least two electrodes;
c) a voltage controller for applying a voltage of a first polarity to the connections for a first period of time;
d) the voltage controller applying a voltage of a second, reversed, polarity to the connections for a second period of time;
e) the voltage controller repeating steps c) and d) a plurality of times;
preferably with steps c), d) and e) promoting oxidation of one or more of the one or more species for treatment.

The second aspect of the invention includes apparatus and component parts therefore for implementing and/or providing each of the features, options and possibilities defined elsewhere within this document, and in particular within the first aspect of the invention.

According to a third aspect of the invention there is provided a method of calibrating the operating conditions to be used in a method of treating a volume of material, the method including:
a) introducing at least two electrodes into a location, the location containing a sample of the material or the volume of material, the sample or the volume of material containing one or more species for treatment;
b) providing connections between a voltage source and the at least two electrodes;
c) applying a voltage of a first polarity to the connections for a first period of time, under the control of a voltage controller;
d) applying a voltage of a second, reversed, polarity to the connections for a second period of time, under the control of the voltage controller;
e) detecting the current arising within the sample or volume of material;
f) varying one or more characteristics of the voltage;
g) detecting the current arising within the sample or volume of material with the revised characteristics of the voltage;
h) further varying one or more characteristics of the voltage until a defined current pulse profile is detected.

The sample could be a sample taken from the volume of material. The sample could be a sample of material believed to have or having equivalent properties to the volume of material.

The detected current may vary according to one or more of the circuit resistance, the electrical conductivity of the material, the electrical conductivity of the matrix within the material, the electrical conductivity of the fluid within the material and/or one or more species within the material, and/or the number of electrodes provided within the material and/or the positions and/or separations of the electrodes within the material.

The defined current pulse profile sought may include a first section. The defined current pulse profile may include a second section, preferably following on directly from the first section. The defined current pulse profile may include a third section, preferably following on directly from the second section or following on from a fourth section. The defined current pulse may include a first reversed section. The defined current pulse profile may include a second reversed section, preferably following on directly from the first reversed section. The defined current pulse profile may include a third reversed section, preferably following on directly from the second reversed section. The defined current pulse profile may include repeats of the sections, particularly with the first section following on directly from the third reversed section.

The first reversed section may have the equivalent profile shape but with a reversed current direction compared with the first section. The second reversed section may have the equivalent profile shape but with a reversed current direction compared with the second section. The third reversed section may have the equivalent profile shape but with a reversed current direction compared with the third section.

The first section may have a start current value and an end current value. The first section start current value may be zero. The first section end current value may be the maximum current for the defined current pulse profile. The first section may last for a first time period. The first time period may be less than 0.5 ms, more preferably less than 0.1 ms and ideally less than 0.05 ms. The first reverse section may be similarly provided.

The second section may have a start current value and an end current value. The second section start current value may be the maximum current for the defined current pulse profile. The current may decline between the start current value and the end current value. The end current value may be a declined current value. The declined current value may be the current value which occurs with the prolonged, for instance greater than 500 ms, application of the voltage in the corresponding part of the voltage pulse profile. The declined current value may be the value the current declines to, from the maximum current value, with the passage of time but represents a steady state current reached after a period of time. The decline current value may continue at that declined current value for a fourth section of a current pulse profile, with the fourth section intermediate the second section and the third section of the defined current pulse profile.

In the defined current pulse profile, a fourth section may be preferred. The fourth section may provide the, or a part of the, pulse section during which the volume of material or a part of the volume of material becomes charged. The fourth section may provide the charge which contributes to the second reversed section of the current pulse profile, for instance by contributing to the higher value of the current during the second reversed section of the current pulse profile. The fourth section may provide the charge which contributes to the first reversed section of the current pulse profile having a higher maximum current value that the minimum current value of the second reversed section, for instance by contributing to the higher value of the current during the first reversed section of the current pulse profile.

In the defined current pulse profile, a fourth reversed section may be preferred. The fourth reversed section may provide the, or a part of the, pulse section during which the volume of material or a part of the volume of material becomes charged. The fourth reversed section may provide the charge which contributes to the second section of the current pulse profile, for instance by contributing to the higher value of the current during the second section of the current pulse profile. The fourth reversed section may provide the charge which contributes to the first section of the current pulse profile having a higher maximum current value that the minimum current value of the second section, for instance by contributing to the higher value of the current during the first section of the current pulse profile.

The first section and/or second section may have a current value in excess of the fourth section current value due to the discharge of the charge provided to the volume or material or a part of the volume of material during the immediately previous fourth reversed section.

The first reversed section and/or second reversed section may have a current value in excess of the fourth reversed section current value due to the discharge of the charge provided to the volume or material or a part of the volume of material during the immediately previous fourth section.

In the defined current pulse profile it may be provided that no fourth section is present. It may be preferred that the end of the decline in current represents the transition point to the third section of the defined current pulse profile.

The second section may have a generally elliptical shape, with an initial rapid decrease in current and then decreasing rate of current decline down to the declined current value. The second reverse section may be similarly provided. Potentially there is no fourth reverse section between the second reverse section and the third reverse section in the defined current pulse profile.

The second section of the defined current pulse profile and/or the second reverse section of the defined current profile may have a duration of between 10 ms and 500 ms, more particularly between 20 and 200 ms.

The fourth section and the fourth reverse section may be absent from the defined current pulse profile, but may be present with a duration of less than 5 ms and more preferably less than 1 ms and ideally less than 0.5 ms. In an alternative embodiment, the fourth section may have a duration of at least 1 ms, potentially of at least 15 ms, preferably at least 50 ms, optionally at least 100 ms and potentially at least 500 ms. For instance, the duration may be between 1 ms and 500 ms, or for instance between 10 ms and 500 ms, more particularly between 20 and 200 ms.

The calibration method may vary the voltage to reduce the duration of and/or eliminate the presence of the fourth section and/or provide a desired duration. The desired duration may be the duration which provides for a given degree of charging of the location and preferably the matrix therein or the surfaces of the matrix. The given degree of charging may be at least 70% of the natural capacitance, more preferably at least 80% and ideally at least 90%. The natural capacitance may be considered relative to the electrical potential being applied across the matrix and/or the separation of the electrodes and/or the distance from the electrodes.

The calibration method may vary the voltage to ensure that the declined current value is reached.

The calibration method may vary one or more of the following when varying the voltage: the duration of one or more of the above defined sections for the voltage pulse profile; the magnitude of the voltage; the polarity of the voltage; the shape of the voltage pulse profile.

The calibration method may provide iterative changes to the voltage and consider the current pulse profile arising, with the iterative changes continuing until the defined current pulse profile is reached.

The third section may have a start current value and an end current value. The third section start current value may be less than the maximum current for the defined current pulse profile and/or may be the declined current value. The third section end current value may be zero. The third section may last for a third time period. The third time period may be less than 0.5 ms, more preferably less than 0.1 ms and ideally less than 0.05 ms. The third reverse section may be similarly provided.

The first and/or second and/or third aspects of the invention may include any of the features, options or possibilities set out elsewhere in this application, including with the other aspects of the invention and the description which follows.

### BRIEF DESCRIPTION OF THE DRAWINGS

The invention will now be described, by way of example only, and with reference to the accompanying drawings in which:

FIG. 1a is a schematic perspective view of a volume of matrix and compounds being treated according to an embodiment of the invention;

FIG. 1b is a detailed view of part of the schematic of FIG. 1a and showing pH treatment;

FIG. 2 is an illustration of the voltage pulse shape applied to the electrodes in the matrix over a series of pulses;

FIG. 3a is an illustration of a detailed view of a part of the current pulse shape, showing the preferred form of that part of the pulse in one embodiment of the invention;

FIG. 3b is an illustration of the same detailed view of a part of the current pulse shape as FIG. 3a, but with too long a duration before the polarity is reversed for that embodiment of the invention;

FIG. 3c is an illustration of the same detailed view of a part of the current pulse shape as FIG. 3a, but with too short a duration before the polarity is reversed for that embodiment of the invention;

FIG. 4 is a schematic illustration of the use of the invention in another situation;

FIG. 5 is a schematic illustration of a still further embodiment of the invention;

FIG. 6 illustrates results for the operation of the method on one mixture;

FIG. 7 is a schematic illustration of the use of the invention in another situation where an emulsion layer requires treatment

FIG. 8a illustrates an alternative current pulse shape provided in an embodiment of the invention;

FIG. 8b illustrates a detail of a part of the current pulse shape of FIG. 8a

### DETAILED DESCRIPTION OF THE PREFERRED EMBODIMENTS

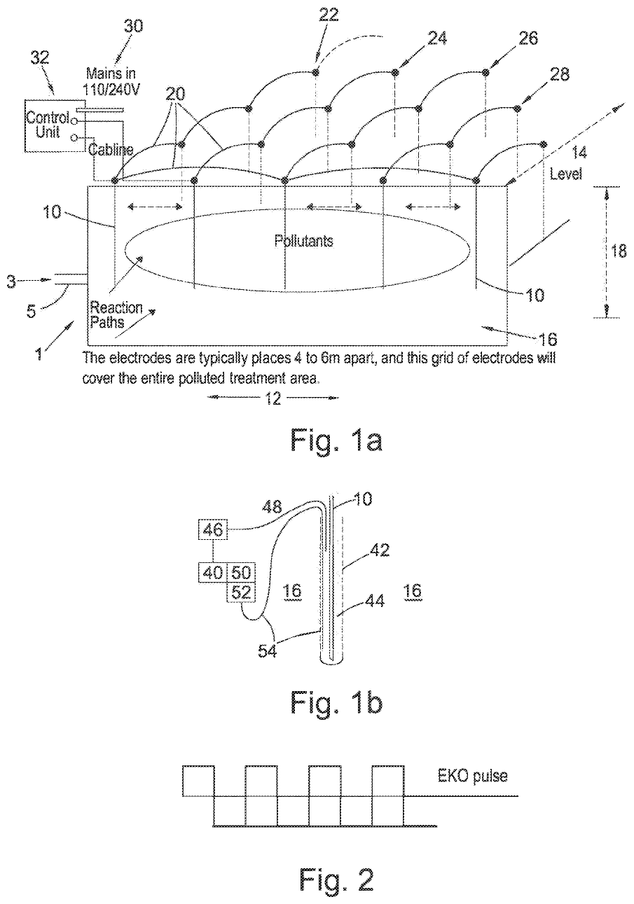

In FIG. 1, a large tank 1 is provided which is designed to have significant capacity for the storage of a mixture 3 which is fed to the tank via inlet 5 from a previous process, not shown. The mixture 3 includes solids, liquids and compounds arising from the previous process.

For example, the previous process may be a drilling operation and the mixture 3 may be a drilling sludge containing a mixture of heavy and light hydrocarbons, clay and salt water or brine.

Previous treatment attempts at the treatment of the mixture 3 may have included settling and decanting the liquid, in-situ chemical treatment or the removal of part of the mixture for treatment in another stage. These all have limitations in terms of costs and/or effectiveness and they are also time consuming to achieve.

The present invention provides a series of electrodes 10 arranged across the length 12 and width 14 of the matrix 16 in the form of the mixture 3. The electrodes 10 also have a depth 18 within the matrix 16. The electrodes 10 are provided in a regular array in this example, but other configurations can be used. Titanium (with a mixed oxide coating or surface, to avoid any insulating layer) and steel represent preferred materials for the electrodes. The electrodes are typically 5 m to 10 m apart from each other along the width and the length of the regular array. The electrodes will typically extend down at least 50% of the depth of the matrix 16 being treated. The electrodes typically have a diameter in excess of 1 cm. The wiring 20 for the electrodes 10 connects them as a first set 22 of electrodes 10, a second set 24 of electrodes 10, a third set 26 of electrodes 10, a fourth set 28 of electrodes 10 and so on. The potential is applied so as to generate a voltage drop between the first set 22 of electrodes 10 and the second set 24. A voltage drop is also generated between the third set 26 and the fourth set 28. This also generates a voltage drop between the second set 24 and third set 26 and between other sets of electrodes 10. The flexibility of the connections provided by the wiring 20 allows for different combinations of electrodes 10 to be connected to form pairs. Suitable power sources 30 and power control units 32 are provided to generate the desired voltage drops and potentials within the system, and hence voltage pulses. The system is driven with a constant voltage supply, typically from 6V to 25V. Thus the current output level depends upon the circuit resistance. The circuit resistance is affected by the electrical conductivity of the matrix 16, and particularly the fluid contained therein, as well as the number of electrodes provided and the separation between them.

The profile of the voltages applied and the impact of the applied voltages on the matrix and compounds are described further below.

During the method, the process conditions are most effective when the pH is within certain bounds. Natural redox reactions and/or reactions caused by the operation of the method can cause a decrease in pH around the anode and/or an increase in pH around the cathode. If the pH becomes too low then electro-osmosis at the anode stops which impairs the operation of the process. If the pH becomes too high then that can have deleterious effects on the process, for instance heavy metal ions may no longer be present in soluble form for removal (the specific pH varies with the specific heavy metal(s) being treated). However, it is believed that the process is still effective at lower pH's than can be tolerated in electro-osmotic based processes where transportation is being sought, as the process is seeking to provide oxidation of organic species.

To ensure the appropriate pH, the system, as shown in detail in FIG. 1b, may include additional water treatment apparatus 40. The water treatment apparatus 40 receives water from around the electrodes 10. A perforated tube 42 is provided around each electrode 10 so as to provide a reservoir 44 of water in contact with the matrix 16. Pumps 46 draw water from the reservoirs 44 along pipes 48 to the water treatment apparatus 40. The water treatment apparatus 40 includes a pH adjustment stage 50 and a heavy metal ion removal stage 52, for instance ion exchange or the like. Clean pH adjusted water arises from these stages and can be returned via pipes 54 to the reservoirs 44. In this way optimum water conditions are provided within the reservoirs 44 and for the process as a whole.

Significantly, the power consumption with the approach of the invention is very low. The voltage pulse profile is illustrated in FIG. 2. As can be seen, the voltage pulse profile consists of alternate pulses of opposite polarities with time. The voltage pulses are generally square shaped pulses for both polarities and are of equal duration. Hence, the pulses are used to apply the voltages to the matrix 16 but have no net transport effect on the matrix 16 or more particularly the liquid and compounds within it.

The square voltage pulse profile features a rapid change from one polarity to the other and then back again. Thus regular square shaped pulses are provided rather than a sinusoidal or other gradual form of changing pulse.

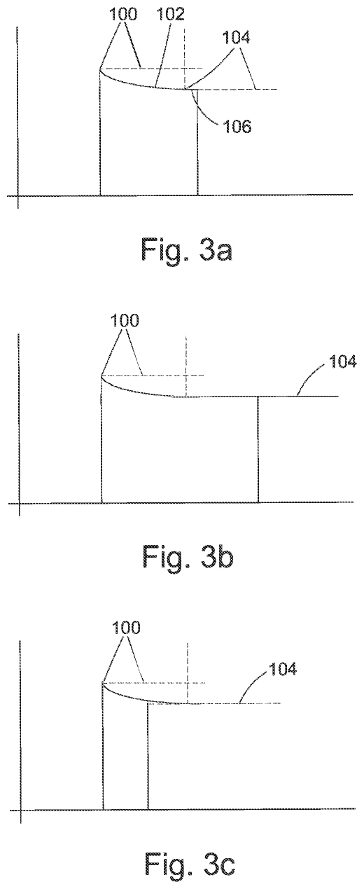

Whilst the voltage pulse profile is generally square shaped, there are important details in the shape of the current pulse which are sought for the optimum operation of the invention. As shown in FIG. 3a, when the rapid change in polarity is applied, the current profile rises quickly and reaches a maximum level 100. From the maximum level 100 the level gradually declines, for instance along an elliptical curve 102, to a reduced consistent level 104. A short time 106 after the reduced consistent level 104 is reached, the polarity is reversed and the current profile quickly switches to a maximum level, not shown, of the opposing polarity.

Typical voltage pulse lengths are between 20 and 200 ms. Short rests may be provided to the system between pulses of one polarity and the other. The rests may be 0.5 ms to 50 ms in duration.

The maximum level 100 is reached as a consequence of the voltage applied causing the matrix, and potentially the liquid, to become charged according to the natural capacitance of the system. This charge is gradually discharged overtime as reflected in the current pulse shape. The maximum level 100 and gradual reduction is indicative of the formation of free radicals within the matrix. These are very beneficial to the overall process, in particular these free radicals are believed to be involved in the oxidation reactions which treat the compounds, such as contaminants.

Beneficially the free radicals are generated exactly where they are needed for the method to provide the desired treatment, namely at the pore surfaces within the matrix. As a consequence, redox reactions are promoted at those locations too.

The duration of the pulse is beneficial in generating electro-osmotic forces in a first direction, and then when the polarity is reversed, in the opposite direction for any one species present (depending upon its charge). Thus the charged contents of the pore water move quickly back and forward with the polarity changes. This causes freshly formed oxygen and hydroxyl free radical formed in these electrochemical reactions to move back and forth. This also promotes their involvement in the oxidisation of the compounds present. For instance the free radicals can cause hydrocarbon chains to breakdown into lighter fractions and form carbon dioxide and water as by products. The capacitive nature of the matrix and reactions occur at the grain surface where the pollution is.

The physical nature of the matrix in many cases, small particulate matter with a moderate or low degree of compaction, means that the electrophoretic forces generated (which generally oppose the direction of electro-osmotic forces) cause small amounts of movement by the particulate material. This is particularly the case for grainy materials and/or particles in slurry or sludge like matrices. The movement is believed to be beneficial in causing reaction product displacement away from the surfaces and/or pH balance.

The process conditions are optimised to give the desired current pulse profile illustrated in FIG. 3a in one embodiment. The overshoot in the level and the current pulse length which gives the full gradual discharge are desirable.

FIG. 3b illustrates a situation where the duration before the polarity is reversed is potentially too long. As a consequence, the same maximum level 100 is provided and the same gradual decay to the reduced consistent level 104, but that level is present for a much longer time frame. This reduced consistent level 104 is believed to reduce the efficiency of the process reactions as the free radical generation has stopped or is present at a lower rate during this phase. However, it may assist with the charging for the reversed polarity part and hence with the effects desired from that reverse polarity when it too discharges.

FIG. 3c illustrates another version of the same current pulse, but with a shorter time period before the polarity is reversed. As a result, the maximum level 100 is present but the reduced consistent level 104 has not been reached by the time the polarity is reversed. As a result it is believe that some of the free radical generating capacity within the system is not exploited and instead energy must be used to reverse the remaining natural part of the capacitance of the system. A detrimental effect on the charging for the reverse polarity part may also occur as a result.

The power supply conditions needed to provide the current pulse profile of FIG. 3a may vary from matrix to matrix and compound to compound situations. However, investigative measurements can be conducted on the particular system to provide the power supply conditions necessary for the desired profile shape and hence process conditions within the matrix.

The role of the free radicals generated is to promote oxidisation reactions. Similar oxidising reactions are used in bioremediation and/or chemical treatment, but the method in which they are generated and promoted is different in this process. The conditions in the matrix are optimised in the present invention, thus adding strength of oxidising to any naturally occurring bioremediation and/or chemical treatment.

Test operations have demonstrated that the process is effective to oxidise a wide variety of organic compounds. Examples include aliphatic organics with C10 to C40, benzene, toluene, ethyl benzene, xylenes, polycyclic aromatic hydrocarbons, chlorinated phenyls, polychlorinated biphenyls and dioxins, as well as PFOS, PFOA.

Further experimental results from the treatment of a first polluted mixture containing polycyclic aromatic hydrocarbons and taken from an in-situ, real world occurrence of the pollutants are detailed in the table below. Samples were taken from Sampling Point 1 at a location in the mixture which was representative of the mixture's pollutant content, at different times after the commencement of the treatment process. The pollutants are measured in terms of mg/kg of sample.

| | | Two | Three | Fourth |
|---|---|---|---|---|
| Sampling point 1 | Time 0 | Months | Months | Months |
| Naphatalene | 0.073 | 0 | 0 | 0 |
| Acenaphtalene | 0.071 | 0 | 0 | 0 |
| Acenaphthylene | 0.024 | 0 | 0 | 0 |
| Fluorene | 0.066 | 0 | 0 | 0 |
| Phenantrene | 0.302 | 0.035 | 0 | 0 |
| Anthracene | 0.076 | 0 | 0 | 0 |
| Fluoranthene | 0.742 | 0.094 | 0 | 0 |
| Pyrene | 0.662 | 0.102 | 0 | 0 |
| Benzo(a)anthracene | 0.131 | 0 | 0 | 0 |
| Chrysene | 0.471 | 0.026 | 0 | 0 |
| Benzo(b)fluoranthene | 0.518 | 0.049 | 0 | 0 |
| Benzo(k)fluoranthene | 0.26 | 0 | 0 | 0 |
| Benzo(a)pyrene | 0.198 | 0.036 | 0 | 0 |
| Indeno(1,2,3-cd)pyrene | 0.192 | 0 | 0 | 0 |
| Dibenz(a,h)anthracene | 0.035 | 0 | 0 | 0 |
| Benzo(g,h,i)perylene | 0.215 | 0.02 | 0 | 0 |

As can be seen from the above results, the treatment process results in material reduction in the extent of a wide range of different organic species present in the mixture at the outset. With three months treatment, each of the organic species is practically eliminated by conversion to carbon dioxide or other low molecular weight organic species.

Further evidence of the effectiveness of the treatment process is seen in the results obtained from the treatment of a second polluted mixture, this time containing perchloroethylenes and tricholorethylenes. In this large scale sample treatment two sampling points at a material distance from one another were used to evaluate the process over time. The contaminants are expressed as μg/kg of sample.

| Sampling point 1 | Mar-15 | May-15 | Jun-15 | Jul-15 | Reduction |
|---|---|---|---|---|---|
| Pentachloroethylene (PCE) | 341365 | 51450 | 94982 | 2718 | 99% |
| Trichloroethylene (TCE) | 4079 | 1803 | 1152 | 290 | 93% |
| Sum of 1,2 dicloroethylenes | 35044 | 4975 | 8570 | 2930 | 92% |
| Sampling point 2 | Mar-15 | May-15 | Jun-15 | Jul-15 | |
| Pentachloroethylene (PCE) | 46320 | 43879 | 51643 | 35128 | 24% |
| Trichloroethylene (TCE) | 2593 | 2277 | 2817 | 1345 | 48% |
| Sum of 1,2 dicloroethylenes | 8777 | 7048 | 7790 | 5562 | 37% |

Again, a very material improvement through the reduction of the level of organic pollutants present is achieved.

The following table provides evidence of the increased oxygen content present in a sample treated according to the present invention. This is a third example and again features a variety of pollutant species within it. A series of eight separate sampling points were used for the measurement of the oxygen content; expressed as mg/l.

Oxygen Content in Ground Water

| Sampling | Day 0 | Day 44 | Day 73 | Day 108 |
|---|---|---|---|---|
| Point | Start value | From start | From start | From start |
| SP 1 | 1.63 | 3.41 | 1.74 | 2.72 |
| SP 2 | 1.05 | 0.80 | 1.63 | 1.40 |
| SP 3 | 0.59 | 1.57 | 0.62 | 1.10 |
| SP 4 | 1.66 | — | 1.81 | — |
| SP 5 | 0.83 | 1.53 | 1.60 | 1.77 |
| SP 6 | 2.68 | 2.70 | 2.08 | 2.36 |
| SP 7 | 2.16 | 2.57 | 1.05 | 1.02 |
| SP 8 | 1.81 | 3.04 | 2.06 | 2.94 |

Whilst readings were not possible from all sampling points at all times, the table clearly shows the immediate increase in the oxygen content and the maintenance of this at enhanced levels over time.

The oxygen generated is beneficial to the treatment process in a number of ways, including the promotion of conditions suitable for microbes already present, with those microbes having an enhanced bioremediation effect as a result.

By changing the pulse shape it is possible to cause a net movement of the water through the matrix and/or of soluble heavy metal ions. In this respect, the square pulse approach is retained, but the duration of the pulse of one polarity is made longer than the other such that there is net transportation which is not fully counteracted when the polarity is reversed. Generally the pulse operative in the direction of travel will be between twice and five times the duration of the opposing polarity pulse in such cases. A rest with no or little applied voltage may be used between polarity reversals. Other movement mechanisms can be used to replace or supplement the movement caused by the potential's polarity, for instance the application of pressure to the fluid within the system.

The process has many beneficial effects upon the matrix and/or upon the compounds within it. These include:
Breaking down one or more compounds present to smaller compounds—these may have reduced toxicity or other undesirable characteristics and/or may be more mobile within the matrix or even soluble;
Reducing the level of contaminants present in the water drawn off the system, other through breakdown those compounds or changing their form;
Changing the surface chemistry of the matrix or species which form the matrix—either in terms of the physical chemistry of the matrix itself or in terms of the ions or other species present at the surface or the charge level of the surface—these can promote better settling of the matrix and/or flocculation of the matrix or other desirable actions—these can result in a large reduction in the volume of the matrix compared with its untreated form—in some test results a volume reduction to 50% or less of the volume observed before treatment started were observed.

The process can be used to treat a wide variety of matrices including soil, groundwater, aquifers and sludges from industrial processes, sewage, contaminated land or soil or material, including when excavated and removed to a treatment site or dumping site.

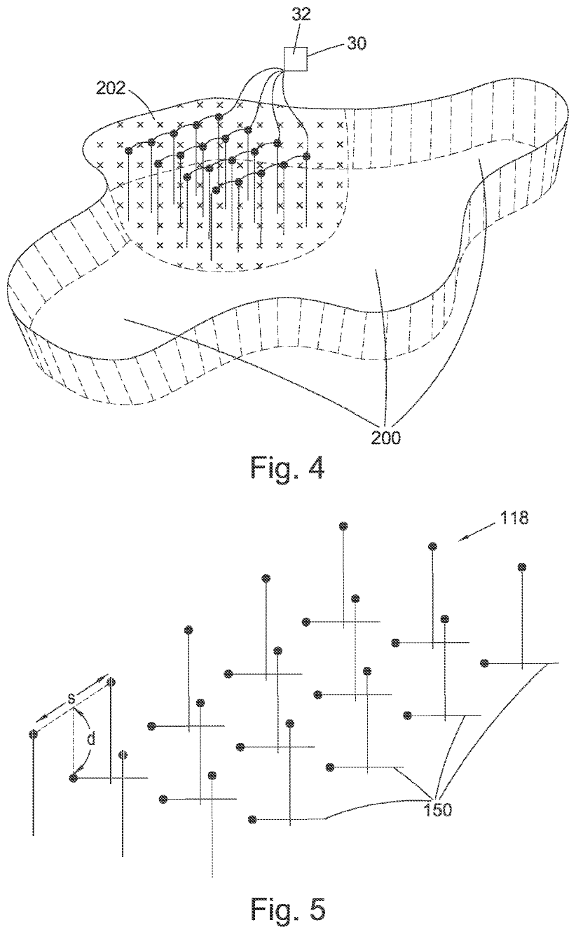

FIG. 4 illustrates an embodiment of the invention similar to the embodiment in FIG. 1, but deployed on a larger scale matrix 200 and only in respect of a part 202 of that matrix. In this case, the matrix and the compounds are less susceptible to the negative effects of pH variation and so those aspects of the process relating to the control of pH have been omitted. Otherwise, similar elements are given matching reference numerals to those in FIG. 1 and the accompanying description.

Other scenario where the invention can be deployed include high liquid content and low matrix content systems such as lakes, ponds or the sediments within them.

FIG. 5 illustrates a further embodiment of the invention in which the vertically arranged electrodes 100 are provided in a similar regular array 118 to the FIG. 1 embodiment. In this cases, however, a series of horizontally extending electrodes 150 are provided. These are connected to the same wiring system. They can be used to form pairs of electrodes amongst themselves and/or be combined with vertically provided electrodes. These electrodes are provided at a depth d below the surface s of the volume of material. These electrodes can be driven into the matrix, placed in drilled holes or inserted in other ways. For instance, the generally horizontal electrodes may be allowed to settle into the material to reach the desired location. The generally horizontal electrodes may be rods or wires or cables, ideally devoid of insulating material. They are used in a similar manner to the vertical electrode operation described above. The combination of electrode arrangements is used to increase the volume of material being treated or in closer proximity to an electrode. The combined use of generally vertical and generally horizontal electrodes is preferred.

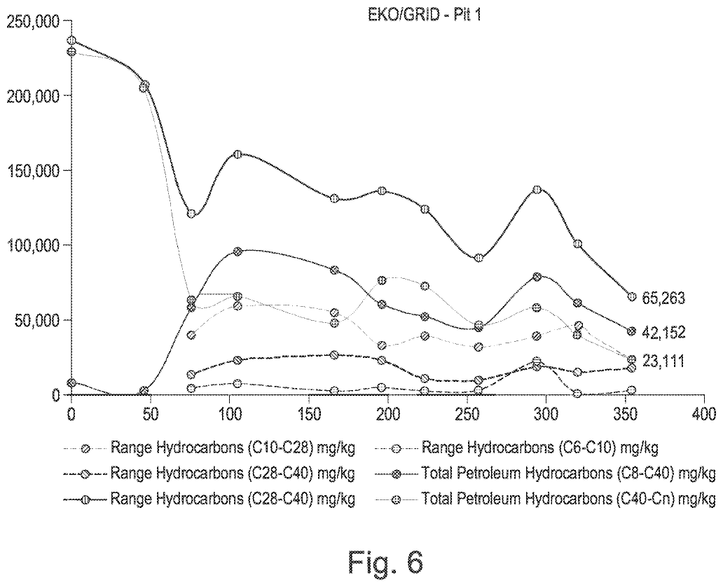

FIG. 6 illustrates the variation observed in a number of characteristics of a mixture when treated according to the method of the present invention over an extended time (in hours) on the x axis.

At the start of the method, the heavier hydrocarbons (black line) are present at a concentration of over 200,000 mg/kg of the mixture. As the method is performed, the method serves to breakdown the heavier hydrocarbons to lighter forms and so the concentration declines. The method reduces the concentration to around ¼ of its original value.

At the start of the method, the lighter hydrocarbons (red line) formed a relatively small part of the mixture and hence the concentration is low at less than 20,000 mg/kg of mixture. As the process converts the heavier hydrocarbons to lighter hydrocarbons, then this concentration increases. The method increases the concentration to around 10 times its original value.

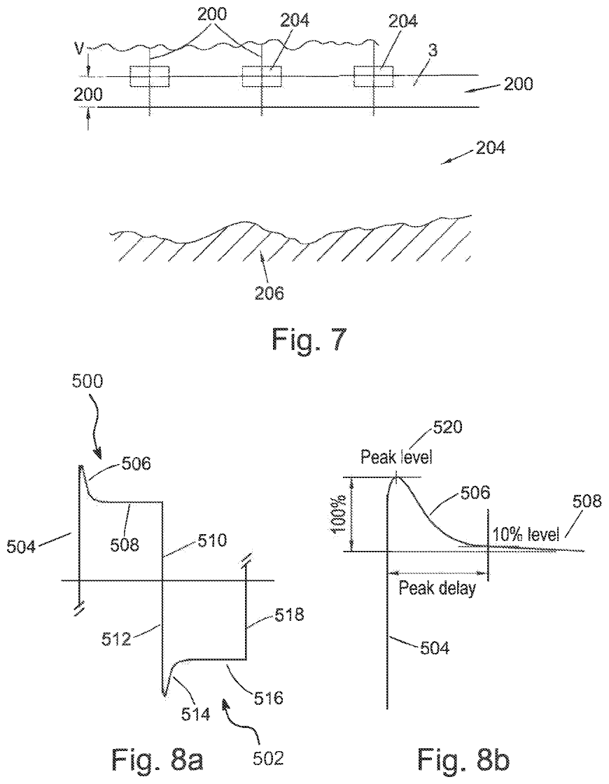

FIG. 7 illustrates an embodiment of the invention similar to the embodiment in FIG. 1, in many respects, but deployed in a completely different situation. In this instance, the hydrocarbons 3 are contained within an emulsion layer 200 present with an appreciable depth 202 on the top of a volume of water 204 in a lake 206 or man-made liquid retaining structure (not shown). These situations are common in Venezuela with nature and man-made occurrences.

As shown, the electrodes 200 are provided in an array 202 supported by floats 204 which are buoyant on the lake 206 and preferably on top of the emulsion layer 200. The electrodes 200 are connected together in sets in the manner described above and the voltage pulse profiles and current pulse profiles described are employed.

The emulsion is formed to a significant degree of asphaltenes and various resins. The oxidation provided by the process of the present invention breaks those species down and so results in the breakdown of the emulsion too, as the resulting species do not or are less capable of forming emulsions. The process results in the release of the oil held up previously in the emulsion and the settling of that oil into layers. The lighter API fraction will form an oil layer on top of the water and any heavier oil layer present will form a layer below the water layer. The layers which form due to gravity settling can then be removed by pumping. The distinct layer of water which forms can also be pumped off, for further treatment or subjected to that further treatment in-situ. The result is the generation of useful oil products with commercial value and the treatment of an otherwise undesirable location from an environmental point of view.

FIG. 8a illustrates a preferred current pulse profile for some methods. Each cycle includes a positive polarity triggered current part 500 and a negative polarity triggered reverse current part 502. The current part 500 is formed of a first section 504, second section 506, fourth section 508 and third section 510 which occur in that sequence. Matching but reversed sections are provided for reverse current part 502, such that it has a first reversed part 512, second reversed part 514, fourth reversed part 516 and third reversed part 518. The next positive current part would then be present as the cycle is repeated over and over by the application of an appropriate voltage pulse profile (not shown).

FIG. 8b shows the peak part of the pulse in more detail. The first section 504 shows the current increasing quickly as it is encouraged by the change in the voltage pulse profile. As a result the voltage induced current and the current caused by the discharge of the capacitance built up during the previous reversed current part (not shown) occurs. These two current elements rapidly cause the peak current 520 to be reached.

1. A method for the treatment of a volume of material causing breakdown of one or more species, the species being organic contaminants in the volume of material the volume of material being a matrix formed of a mixture of liquid and of solids, the solids providing a surface, the volume of material being a slurry or sludge, the method comprising:
a) introducing at least two electrodes into a location, the location containing the volume of material and the volume of material containing one or more species for treatment;
b) providing connections between a voltage source and the at least two electrodes, the voltage source having an output of between 2 V and 50 V;
c) applying a voltage of a first polarity to the connections for a first period of time, under the control of a voltage controller, to generate a current with a defined current pulse profile;
d) applying a voltage of a second, reversed, polarity to the connections for a second period of time, under the control of the voltage controller, to generate a reverse current with a reverse defined current pulse profile;
e) repeating steps c) and d) a plurality of times;
wherein, as a result of the applied voltages:
i) one or more components of the matrix become charged by the current and the reverse current according to the natural capacitance of the system;
ii) free radicals are generated at the surface of one or more of the solids within the matrix due to current and the reverse current;
iii) the defined current pulse profile is provided during step c) in the matrix;
iv) the reverse defined current pulse profile is provided during step d) in the matrix, with a reverse polarity to that of step c);
wherein the defined current pulse profile has a first section, second section and third section,
the first section having a start current value and an end current value, the first section start current value being zero and the first section end current value being the maximum current for the defined current pulse profile, and the first section having a duration of less than 0.5 ms;
the second section having a start current value and an end current value, the second section start current value being the maximum current for the defined current pulse profile and the second section end current value being a declined current value, and the second section having a duration of up to 500 ms; and
the third section having a start current value and an end current value, the third section start current value being less than the maximum current for the defined current pulse profile, the third section end current value being zero, and the third section having a duration of less than 0.5 ms;
wherein, as a result of the applied voltages, a reverse defined current pulse profile is provided during step d) within the matrix with a reverse polarity to that of step c);
wherein the reverse defined current pulse profile has a first reverse section, second reverse section and third reverse section,
the first reverse section having a start current value and an end current value, the first reverse section start current value being zero and the first reverse section end current value being the maximum current for the reverse defined current pulse profile, and the first reverse section having a duration of less than 0.5 ms;
the second reverse section having a start current value and an end current value, the second reverse section start current value being the maximum current for the reverse defined current pulse profile and the second reverse section end current value being a reverse declined current value, and the second reverse section having a duration of up to 500 ms; and
the third reverse section having a start current value and an end current value, the third reverse section start current value being less than the maximum current for the reverse defined current pulse profile, the third reverse section end current value being zero, and the third reverse section having a duration of less than 0.5 ms.

2. The method according to claim 1, in which steps c), d) and e) promote oxidation of one or more of the one or more species for treatment.

3. The method according to claim 1, wherein the treatment reduces the volume of one or more compounds present in the location and/or the treatment reduces the level of one or more compounds present in the location and/or the treatment alters the form of one or more compounds.

4. The method according to claim 1, in which the one or more species is/are one or more of the following: light hydrocarbons (C10 or less), heavy hydrocarbons (C11 or more), benzene, toluene, ethyl benzene, xylenes, polycyclic aromatic hydrocarbons, chlorinated phenyls, chlorophenols, polychlorinated biphenyls, biphenols, perchloroethylenes, tricholorethylenes, dioxins, perfluorooctanesulfonic acids, perfluorooctanoic acids or other hydrocarbons.

5. The method according to claim 1, wherein the voltage is the voltage necessary to achieve an electric field of greater than 0.2V/m across the separation between the electrode of one potential and the electrode of a different potential which is closest to that electrode.

6. The method according to claim 1, wherein the voltage applied is in the form of a voltage pulse profile, the voltage pulse profile having a first section during which the voltage is at a maximum value, the voltage pulse profile having a first reversed section during which the voltage is at a maximum value, but of opposing polarity.

7. (canceled)

8. The method according to claim 1, wherein the defined current pulse profile continues at that declined current value for a fourth section of the defined current pulse profile, with the fourth section positioned intermediate the second section and the third section of the defined current pulse profile and wherein the reverse defined current pulse profile continues at that declined current value for a fourth reverse section of the reverse defined current pulse profile, with the fourth reverse section positioned intermediate the second reverse section and the third reverse section of the reverse defined current pulse profile.

9. (canceled)

10. (canceled)

11. The method according to claim 1, wherein the second section of the defined current pulse profile has a duration of between 10 ms and 500 ms.

12. The method according to claim 8, wherein the fourth section of the defined current pulse profile has a duration that is greater than 500 ms.

13. (canceled)

14. The method according to claim 8, wherein the first section and/or second section have a maximum current value in excess of a maximum current value of the fourth section due to a discharge of a charge provided to the volume or material or a part of the volume of material during an immediately previous fourth reversed section.

15. The method according to claim 1, wherein the second section includes a maximum current value above the declined current value due to the voltage applied causing one or more components of the material to become charged according to the natural capacitance of the system.

16. The method according to claim 8, wherein the fourth section provides a part of the defined current pulse profile during which the volume of material or a part of the volume of material becomes charged with a charge which contributes to the second reversed section of the defined current pulse profile.

17. The method according to claim 1, wherein the method promotes oxidisation by generating free radicals within the location.

18. The method according to claim 1, wherein the method promotes oxidisation by generating free radicals within the material at the surface of solid species within a matrix in the material.

19. The method according to claim 1, wherein the method has one or more or all of the following effects upon a matrix in the material and/or one or more species in the material between a first time at the start of the method's application and a second time after the method has been applied:
a reduction in the concentration of C40 or more carbon atoms hydrocarbons by 20% or more;
an increase in the concentration of C8 to C30 hydrocarbons by more than 100%;
an increase in the concentration of less than C8 hydrocarbons by more than 25%;
a reduction in the concentration of the C8 or greater hydrocarbons by 10% or more;
the conversion of a part of the hydrocarbons to water and carbon dioxide.

20. The method according to claim 1, wherein the method includes repeating steps c) and d) through at least 1000 repetitions.

21. The method according to claim 1, wherein the method has one or more or all of the following effects upon a matrix in the material and/or one or more species in the material between a first time at the start of the method's application and a second time after the method has been applied:
a reduction in the concentration of C40 or more carbon atoms hydrocarbons by 35% or more;
an increase in the concentration of C8 to C30 hydrocarbons by more than 200%;
an increase in the concentration of less than C8 hydrocarbons by more than 50%;
a reduction in the concentration of the C8 or greater hydrocarbons by 20% or more;
the conversion of a part of the hydrocarbons to water and carbon dioxide.

22. The method according to claim 1, wherein the method has one or more or all of the following effects upon a matrix in the material and/or one or more species in the material between a first time at the start of the method's application and a second time after the method has been applied:
a reduction in the concentration of C40 or more carbon atoms hydrocarbons by 50% or more;
an increase in the concentration of C8 to C30 hydrocarbons by more than 500%;
an increase in the concentration of less than C8 hydrocarbons by more than 100%;
a reduction in the concentration of the C8 or greater hydrocarbons by 30% or more;
the conversion of a part of the hydrocarbons to water and carbon dioxide.

23.-29. (canceled)

30. A method for the treatment of a volume of material causing breakdown of one or more organic contaminants in the volume of material, the method comprising:
a) introducing at least two electrodes into a location, the location containing the volume of material and the volume of material containing one or more species for treatment;
b) providing connections between a voltage source and the at least two electrodes, the voltage source having an output of between 2 V and 50 V;
c) applying a voltage of a first polarity to the connections for a first period of time, under the control of a voltage controller;
d) applying a voltage of a second, reversed, polarity to the connections for a second period of time, under the control of the voltage controller;
e) repeating steps c) and d) a plurality of times;
wherein, as a result of the applied voltages, a defined current pulse profile is provided during step c) and step d);
wherein the method includes repeating steps c) and d) through at least 1000 repetitions;
wherein the defined current pulse profile has a first section, second section and third section, the first section having a start current value and an end current value, the first section start current value being zero and the first section end current value being the maximum current for the defined current pulse profile, and the first section having a duration of less than 0.5 ms;
wherein the defined current pulse profile has the second section having a second section start current value and a second section end current value, the second section start current value being the maximum current value for the defined current pulse profile, with the current declining between the second section start current value and the second section end current value, the second section end current value being a declined current value, the declined current value being the value that the current declines to from the maximum current value, with the passage of time and representing a steady state current reached after that period of time, and the second section having a duration of up to 500 ms; and
wherein the third section has a start current value and an end current value, the third section start current value being less than the maximum current for the defined current pulse profile, the third section end current value being zero, and the third section having a duration of less than 0.5 ms.
